(19) United States
(12) Patent Application Publication
(10) Pub. No.: US 2023/0008943 A1
(43) Pub. Date: Jan. 12, 2023

(54) System and Method for Digital Human Learning and Exchange of Concise Formatted Content

(71) Applicant: Lowell Shelton Stadelman, Gainesville, FL (US)

(72) Inventor: Lowell Shelton Stadelman, Gainesville, FL (US)

(21) Appl. No.: 17/676,809

(22) Filed: Feb. 21, 2022

Related U.S. Application Data
(60) Provisional application No. 63/151,641, filed on Feb. 20, 2021.

(51) Int. Cl. G09B 7/02; G09B 23/26

(52) U.S. Cl. CPC G09B 7/02; G09B 23/26

(57) ABSTRACT

Disclosed is a method and system to assure ownership of user sourced materials that conform to a user selectable and/or a machine selectable format. The model consists of software driven behaviors, user selectable formats, and human understandable data. This is a system of systems model where servers conduct organization, processing, and storage. An application resides on the user's electronic processing device, and through a biased data model and determination system, relevant, high quality, and interactive learning materials are matched to a user's specification. The system of systems further comprises of servers that conduct processing and organization in order to provide security, ownership, and synchronization of the originators data and media encompassed with user specified formatting and behavior. Further, the system of systems includes synchronization across multiple users and systems both by electronic processing device and time.

### CROSS-REFERENCE TO RELATED APPLICATIONS

This application claims priority to U.S. Provisional Patent Application No. 63/151,641 filed on Feb. 20, 2021 and entitled “Method and System for synchronization, and ownership assurance with security, for variable machine assisted engagement for user sourced learning with a versatile modeling system for concise learning-information including data and multi-media.”, which is incorporated in its entirety herein by reference.

### PRIOR ART

“List of FlashCard Software”, Wikipedia, the free encyclopedia, URL: http://en.wikipedia.org/wiki/List_of_flashcard_software, Downloaded from the Internet Feb. 14, 2022, 2 pages. cited by applicant.

“Flashcard”, Wikipedia, the free encyclopedia, URL: http://en.wikipedia.org/wiki/Flashcard, Downloaded from the Internet on Feb. 14, 2022, 4 pages. cited by applicant.

### BACKGROUND OF THE INVENTION

Memorialization and learning of new concepts by Flash Cards and note cards is a well-known and popular technique. Flash cards typically contain a question and an answer. Note cards are also popular for memorialization and typically contain a brief statement. Both typically may contain text and may also contain drawings, mathematical concepts, images, and or even the atomic structure of atoms. The range of possible forms of information is limited to the known subjects and the imagination of the creators. The basis we establish is that a flash card or note card contains concise information. Flash cards and note cards are generally organized into decks and are reviewed until sufficiently memorized. As a student or learner learns from the information in the deck, they may reorganize the deck moving “known” information to the bottom of the deck, and “unknown” information to the top. They may also make corrections, add new cards, hide the cards, or remove them.

The application described in this invention departs from the physical idea of a flash card, note card, or any prior art that would be similar to a physical flash card or note card except for its conciseness in data, organization techniques, ability to add, edit, delete, and hide as well as their use for memorialization and learning new concepts.

Additionally, in a typical academic course, there are students who create learning content, and students who ask for the use of the learning content. The learning content has value.

Prior art exists as software and as patents but provide a limited set of functions in comparison to the diverse capabilities that electronics provide and from the changing needs of human learning.

This invention applies an ability for concise information to be learned and memorialized in a variable format and behavior that may be better suited for its subject and the intent of the creator. Prior art provides a flash card with an animation or action such as the flipping of a card to indicate a new set of information. This invention applies the ability for an action to take on a wider flexible range that may for instance walk a user through the ATP process as taught in biology and adds the ability for a user to interact with the information similar to an interactive simulation. The invention allows for the addition of new learning types as users invent them. The invention in comparison to prior art provides an easy to understand and use method for uploading data and multi-media and assignment of a broader range of behaviors. The end result and further departure from prior art is that learners interact with the information in a greater variation to help create a diverse set of memory triggers for difficult concepts.

### SUMMARY OF THE INVENTION

Disclosed is a method and system to assure ownership of user sourced materials that conform to a user selectable and/or a machine selectable format. The model consists of software driven behaviors, user selectable formats, and human understandable data. This is a system of systems model where servers conduct organization, processing, and storage. An application resides on the user's electronic processing device, and through a biased data model and determination system, relevant, high quality, and interactive learning materials are matched to a user's specification. The system of systems further comprises of servers that conduct processing and organization in order to provide security, ownership, and synchronization of the originators data and media encompassed with user specified formatting and behavior. Further, the system of systems includes synchronization across multiple users and systems both by electronic processing device and time.

### BRIEF DESCRIPTION OF DRAWINGS

FIG. 1 is a diagram of an example computing system in which the claims of this invention would be implemented.

FIG. 2a is a top-level diagram of the systems architecture for the application layer.

FIG. 2b is a top-level diagram of the system of systems architecture for the cloud layer.

FIG. 3a is a diagram displaying the Review Mode Wrapper.

FIG. 3b is a diagram displaying the Test Mode Wrapper.

FIG. 3c is a diagram displaying the Create and edit mode wrapper.

FIG. 4 is a diagram of sections and cells.

FIG. 5a is a diagram of example card-type layout for True or False in Create and Edit Mode.

FIG. 5b is a diagram of a Multi-Choice Card Type in Create and Edit Mode

FIG. 5c is a diagram of a Graph-Card Card Type in Create and Edit Mode

FIG. 5d is a diagram of a Note-Card Card Type in Create and Edit Mode

FIG. 6a is a diagram of a Math-Card Card-Type in Create and Edit Mode

FIG. 6b is a diagram of a Math-Card Card-Type in Review-Mode

FIG. 6c is a diagram of a Math-Card Card-Type in Test-Mode

FIG. 6d is a diagram of an example interactive-behavior using the Math Card Card-Type with a Wrong Answer Response.

FIG. 7a is a diagram of a Multi-Choice Card-Type while in test mode. The diagram shows a an image that is exploded to normal size when the cell has been clicked on.

FIG. 7b is a diagram of the Multi-Choice Card-Type while in Create and Edit Mode. The diagram shows that the image and shapes are editable when the cell has been clicked on.

FIG. 8a is a diagram of the Review Mode after key words have been entered into the search area by the user.

FIG. 8b is a diagram of the Review Mode showing the data from one of the hyperlinks that has been clicked on.

FIG. 8c is a diagram of the Status and Navigation Pane showing the behavior of the Displayed tree when in search mode.

FIG. 9 is a diagram of the Status and Navigation Pane showing the behavior of the displayed tree when a deck is reorganized.

FIG. 10a is the 1^{st} UML Flow Diagram of the Resource Exchange System which connects to FIG. 10b and FIG. 10c.

FIG. 10b is the 2^{nd} UML Flow Diagram of the Resource Exchange System and connects to FIG. 10a and FIG. 10c.

FIG. 10c is the 3^{rd} UML Flow Diagram of the Resource Exchange System and connects to FIG. 10a and FIG. 10b.

FIG. 11a is a diagram showing a representation of the UI when a user is conducting a search of the Ecosystem for a Learning Resource.

FIG. 11b is a diagram showing an example representation of the found learning resources of the ecosystem.

### DETAILED DESCRIPTION OF THE INVENTION

The detailed description presents an invention to assist in learning concepts and memorializing information. The novelties of this invention are an intuitive nature to create edit and review content, a variable format for concise information that may range to nearly any learning subject, an ability to vary behaviors and formats to provide a more comprehensive learning experience, an ability for users to publish their creations in a specialized ecosystem for monetary value, and an ability to ensure ownership. Previous digital learning systems do not fully take advantage of the capabilities provided by computing devices for the purposes of learning new materials and memorialization. In comparison to this invention they are limited in their format and behavior which limits the imagination of teaching methods. This invention provides an independent infrastructure for supporting new learning methods without taking credit for them.

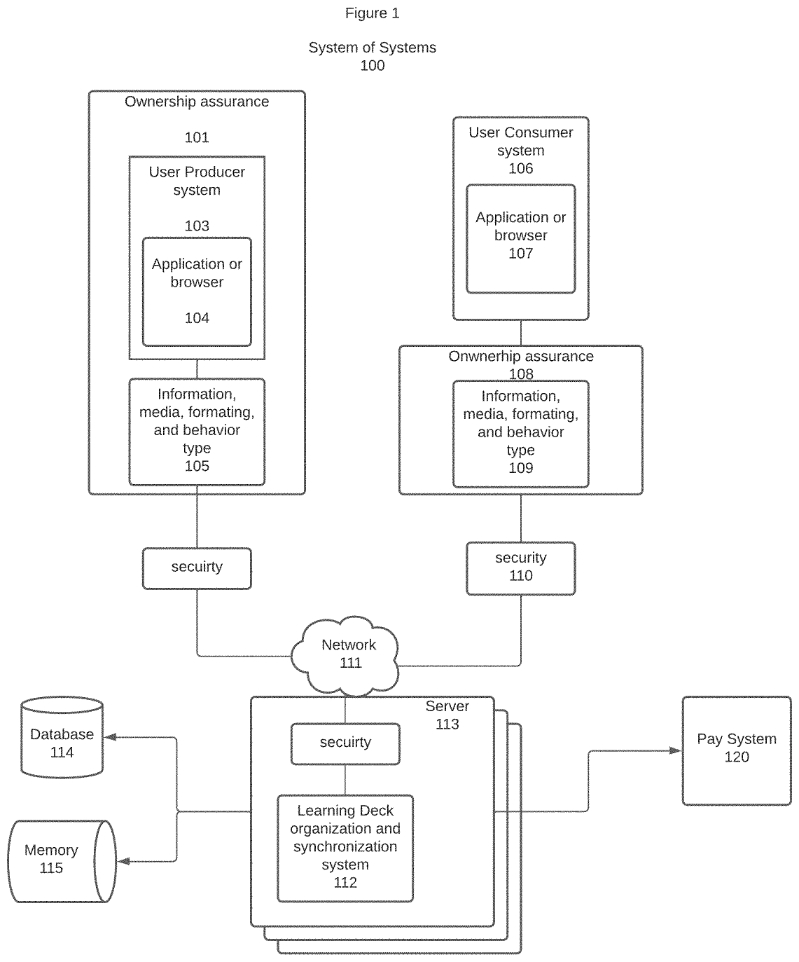

FIG. 1 provides a generalized example of a computing system that is capable of the innovations described by the claims of this invention. The computing system is not intended to suggest a limitation of functionality. The invention described may be implemented in a wide range of general-purpose computing systems.

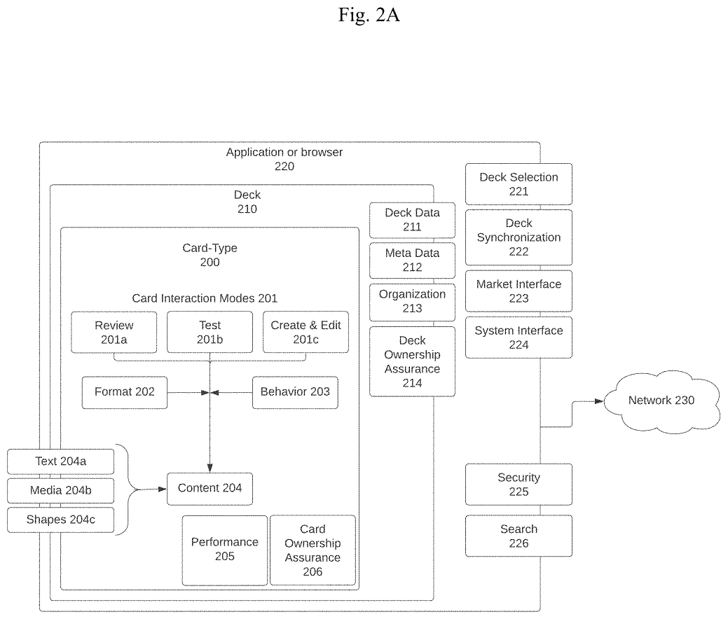

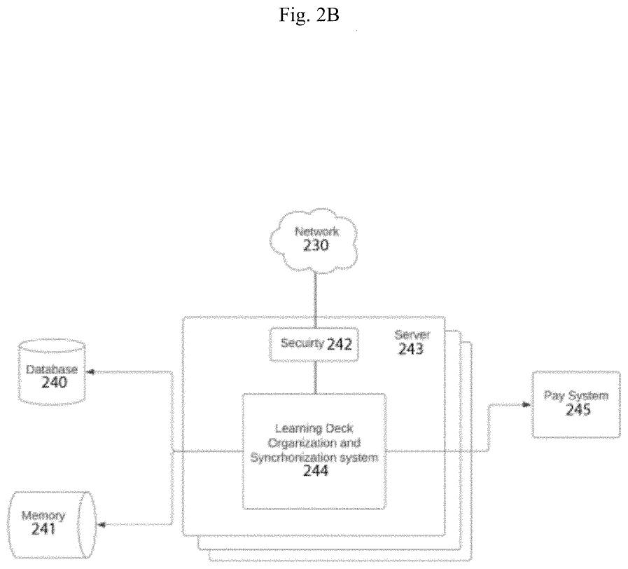

FIG. 2a is a top-level diagram gf the application layer of the system architecture for this invention which would operate in a computing device similar to FIG. 1. The application layer is accessible to the user through a user interface that could be either an application or a browser (220). The application layer consists of Card Interaction Modes (201) that provide a capability to review (201a), test (201b), and create or edit (201c) content (204) based n the Card-Types format (202) and behaviors (203). A card type may provide information about the current user's performance (205) and provides information and methods for Ownership Assurance (206). A card type also in formation about its non-text media. A deck (210) may contain multiple cards with a variation of Card-Types, it's metadata (212) contains information such as usage. price, ratings, author. editors. professor, book. school. and course. It includes information for organization (213) based on user performance that organizes the cards within a deck both during a user session. and in later sessions according to the definition the card type (200). This may be according to the content (204) within the card or may be according to the user's interactions with the card. Decks further contain data for ownership assurance (214). Decks (210) are either created by the current user or purchased through the Market Interface (223). The application or browser also provides an ability for the user to select one of multiple decks (221) for that session. It provides the ability to uniquely name and store files in the local and cloud storage system so that they are synchronized (222) across all systems. The application or browser provides the systems visual interface (224). The application architecture provides methods for restricting access (201) without the proper user credentials (225) both in the application and in communications to the network (230). Search (226) exists within the application and searches through the data contained within a deck.

FIG. 2b depicts the server and the elements that make up the cloud layer. and that communicates with multiple applications over the network (230). The server differs from a standard web server by providing a deck FIG. 2a (210) and its media (204b & 204c) Organization through a Synchronization System FIG. 2b (244). It connects with a database at (240), a cloud storage system for memory at (241), and a payment system at (245).

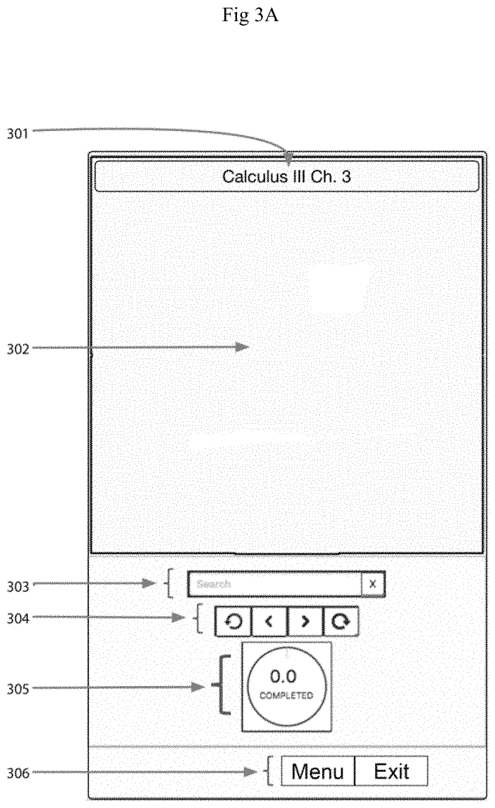

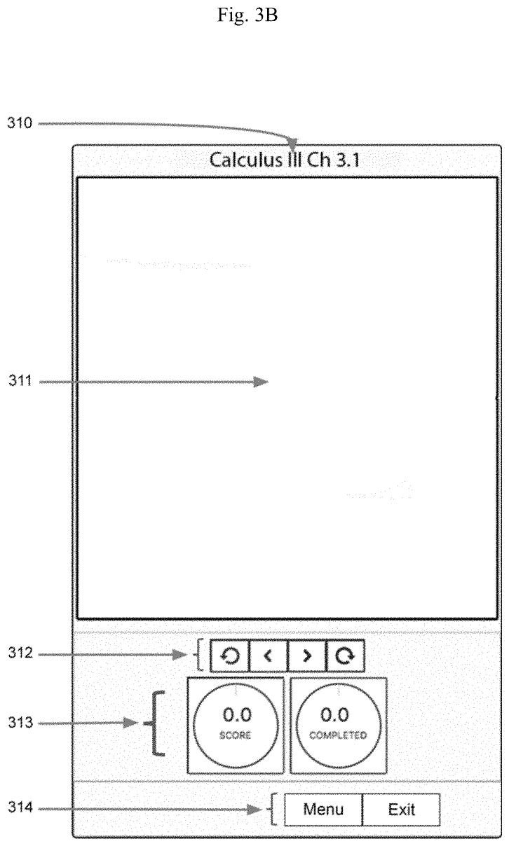

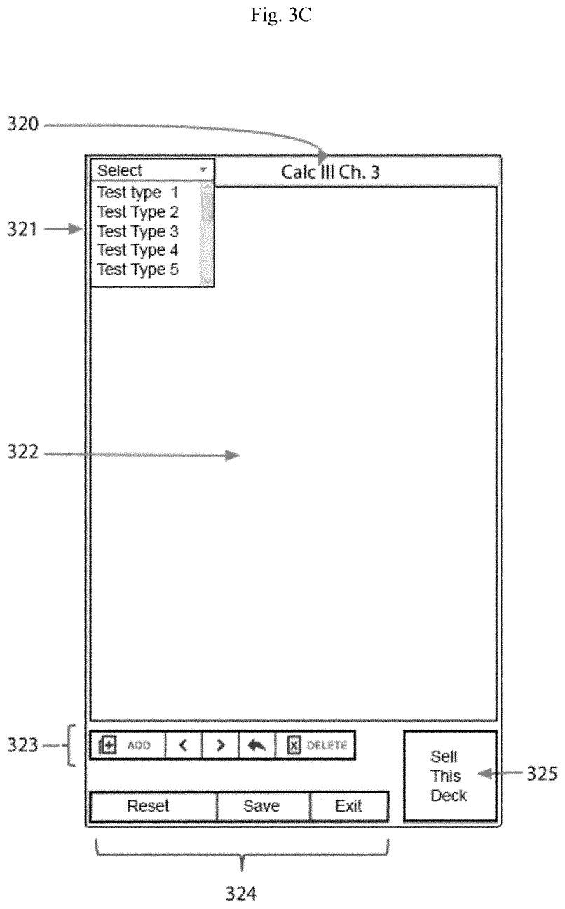

Interaction Modes: The application provides a common wrapper for commonly used Card-Types according to an Interaction Mode that the user has selected. The interaction modes are Review FIG. 2a (201a), Test (201b). and Create and Edit (201c). Card-Types are independent but may share many attributes with each other. Card-Types are displayed according to their definition as non-transitory code and are shown inside the Card Area of their common wrapper. The Card Areas as seen in each Interaction Mode. Review Mode FIG. 3a (302), Test Mode FIG. 3b (311) and Create Edit Mode FIG. 3c (322). Each interaction mode requires a definition as non-transitory code by a Card-Type. Each Card-Type provides the methods as non-transitory code for the intended behavior, and the methods as non-transitory code for the UI formatting for these modes. Card-Types and Common Wrappers are discussed in more detail below in the paragraph [0064] titled “Card-Types”.

Review-Mode: The review mode or review in FIG. 2a (201a), implemented through non-transitory code. provides the methods and format so that a user may learn and review an idea as a/concept as a concise segments. It is not limited to displaying content, it may also provide a segment of a walk-through simulation or the entire walk through as needed by the creator. The Review-Mode Common Wrapper UI seen in FIG. 3a provides a label for the name of the current deck (301), an area where a specific card-type's UI elements and behaviors are displayed (302), a search entry text-area (303) and is discussed in further detail in Search at paragraph [0080], navigation buttons (304) that move through the decks organization sequentially, a gauge that shows the number of cards that have been reviewed (305), and a return to menu and exit keys at (306).

Test-Mode: The Test mode seen in FIG. 2a (201b) provides the methods as non-transitory code and user interface so that a user may be repeatedly tested for their understanding and memorialization of concepts and information. Like review-mode, it is not limited to displaying content. It may also provide an interactive behavior that is different or the same as review mode. The test-mode wrapper UI as seen in FIG. 3b provides a label for the name of the current deck (310). An area where a specific card-type's UI elements and behaviors are displayed for a-card-type's UI elements (311), and navigation buttons (312), gauges to display the number of cards completed and the score (313). The UI also provides a back or menu key as well as an exit key (314).

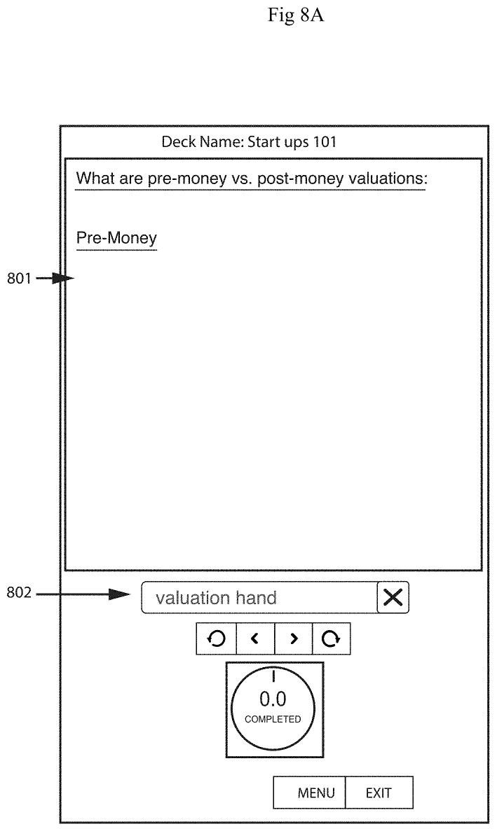

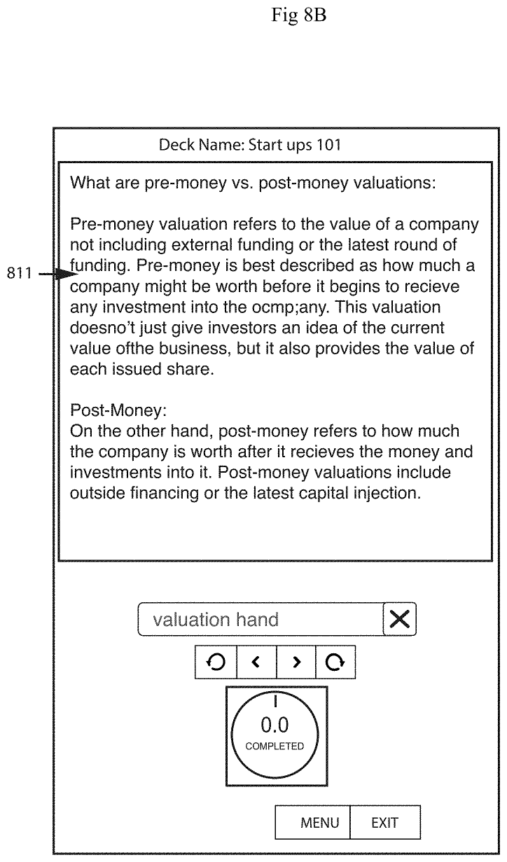

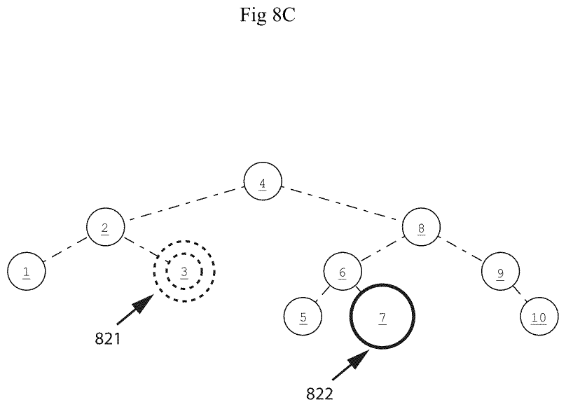

Create and Edit Mode: The create and edit mode as seen in FIG. 2a (201c) provides the methods as non-transitory code and user interface so that a user may create new content, edit existing content, hide or unhide a card, delete content, and adjust or reset the order that cards appear within a deck. The same user interface is provided for both creating and editing content. The wrapper for the create and edit UI as seen in FIG. 3c also provides a label (320) for the current deck being edited and a card-type selection menu (321). Similar to the previous two wrappers it also provides an area for a specific card-type's UI elements (322). The user may select the desired Card Type at the drop-down selector (322). At (323) is an example row of buttons that provide the Create and Edit Mode the user an ability to modify the deck by adding a card. deleting a card. undoing changes to a card and selecting a card in sequential order. The navigation buttons to move sequentially higher or lower or left and right within the deck. The reset button will reset the card back to the data that existed before the user began to make edits. The add button will add a card at the sequential position/index that is being shown both in the Editor UI and in the Status and Navigation Pane FIG. 8. As a brief example if the user presses the add button and the current position is card 7 (822), a new card would be added at (822). Finally, the delete key will delete the card that is displayed in the wrapper window and in the Status and Navigation Pane FIG. 8 in the same manner as the add button. The example row of buttons at (324) allows the user to reset the order of the deck to its original order. The save the changes to the deck. The “sell this deck” button, unique from prior art, will display a form allowing the user to upload meta data about the deck and select to sell it. The meta data describes the deck to other users. The meta data is stored in the database shown in FIG. 2b (325) and is accessible by the exchange system described in paragraph [0001].

Card Types: A Card-Type seen in FIG. 2a (200) has several attributes. The attributes of a card type are a format (202), a behavior (203) and Content (204). The Card-Type is an architecture implemented in non-transitory code that allows flexibility between each card that is displayed to a user. For example. One card may be used to introduce a concept to a user and to discuss the concept using images, videos, sounds and or text. The next card may be to walk the user through the concept in a step by step fashion. The third card may provide more detail for understanding the concept that was discussed in the previous cards, and the fourth card may provide an interactive walk through to help the user understand the information in the third card. This pattern or any other pattern may be defined by the user that creates the content and the deck. A Card-Type, as shown, is defined by a software developer and allows the existence of a large variety of learning and interaction types. The novelty of this invention is that it provides a flexible infrastructure for novel learning methods to be quickly and inexpensively created and to learners. A card type is selectable as shown in FIG. 3c (321), by the user during the cards creation or editing. The card type is then used by the learner's machine as cards are displayed and used within the provided wrappers. Finally, during testing, the card type may be selected based upon performance information from the user's previous sessions, information from other user's performance, or a combination of the two. The information provided by the deck creator may be autonomously reformatted by non-intrinsic code for a compatible but different Card-Types such as a Multi-Choice or Multiple-Answer Card Types.

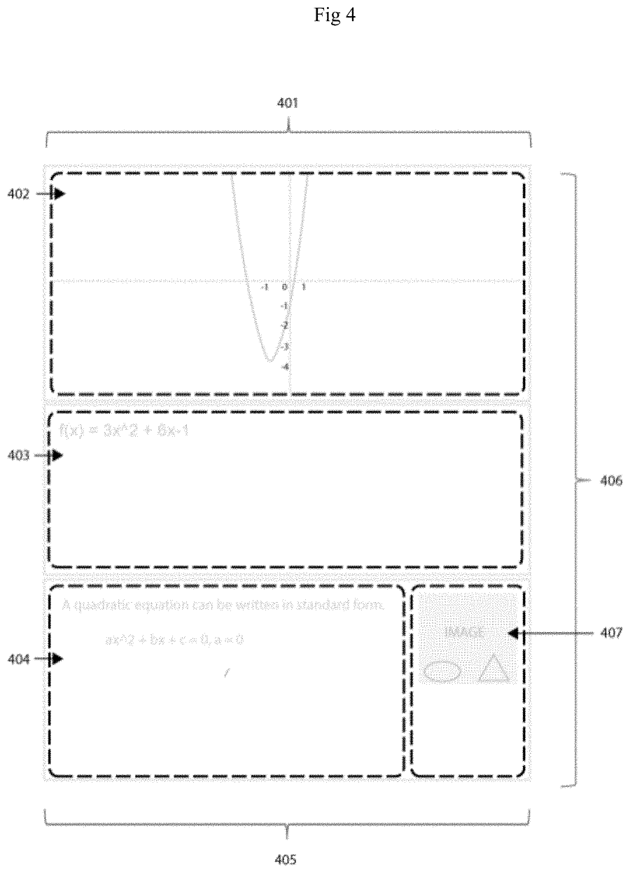

Format: A format FIG. 2a (202) provides the necessary software definitions a non-transitory code to display the content to the user in a human understandable form either on a screen or other visual device. It defines the user interface elements for this card type for each of the three interaction-modes mentioned earlier (review, test, and create). A format, as shown in FIG. 4, is defined in sections (401 and 405) and cells (402, 403, 404, and 407). Sections contain cells. Sections by themselves are merely containers for the cells and provide higher level layout and animations that are related to sections or the locations of the cells. Cells provide the fields for the display or creation of specific content and are discussed further in paragraph [0071] content. Sections as shown in FIG. 4 are stacked vertically (406). or horizontally, not shown. A Card Type may have from 1 to N sections. It may use a common section-type provided by the application or define its own. A section as shown in (405) contains cells aligned horizontally and may contain from 1 to n cells.

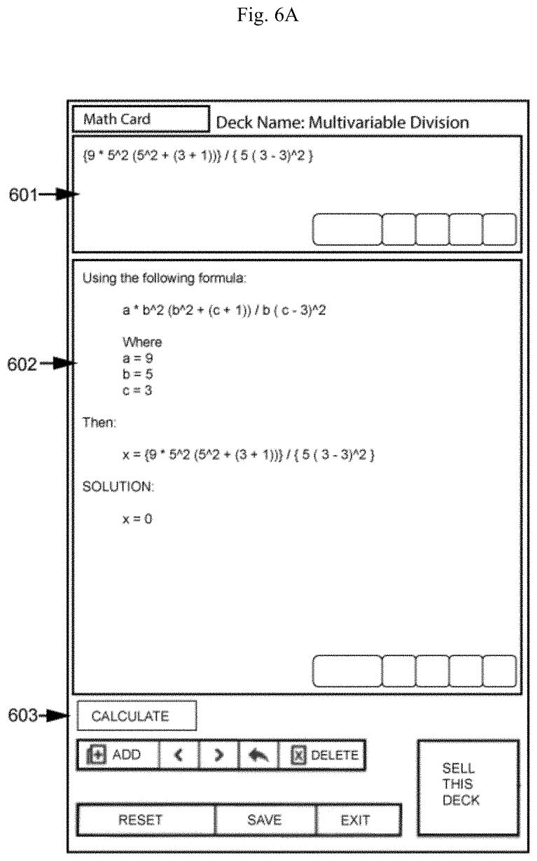

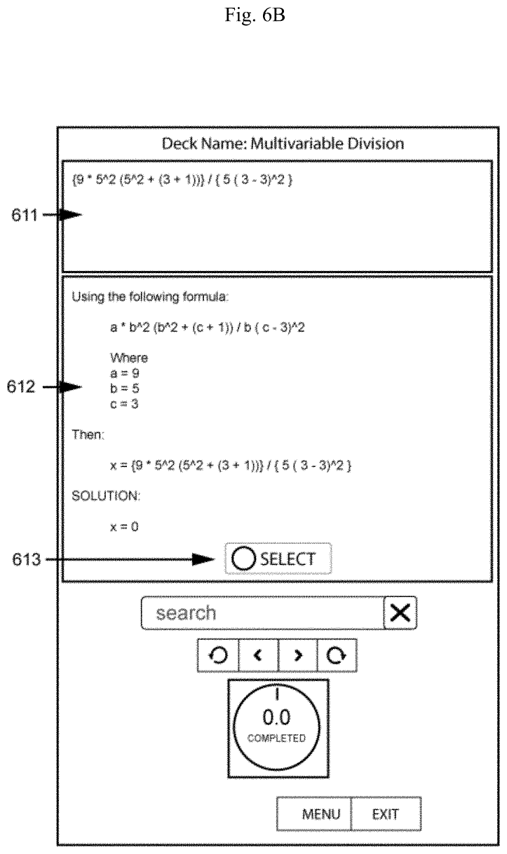

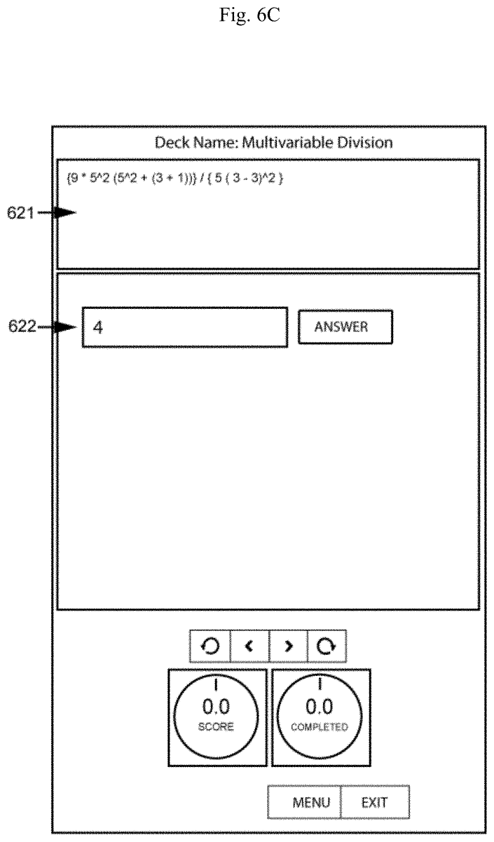

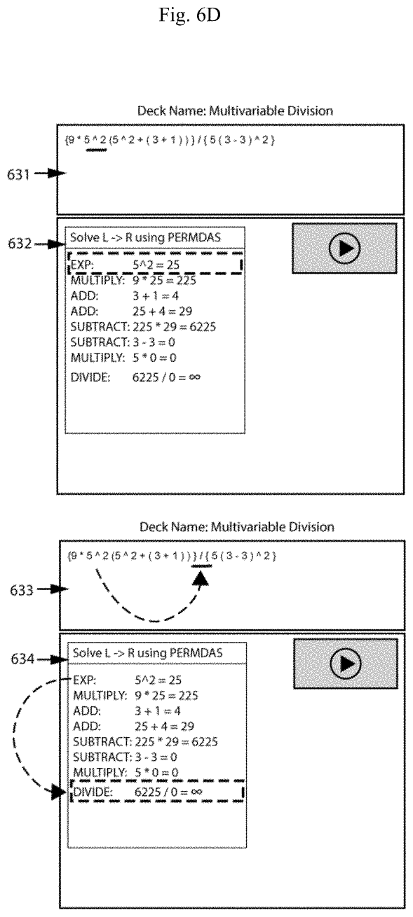

Behavior: A behavior FIG. 2a (203) is an action that is performed such as an animation. The novelty of this invention from prior art is that it also allows a variety of behaviors that are defined in non-transitory code. A behavior may be simple such as the behavior for a question and answer type shown in FIG. 6B. The card begins with the answer area (632) hidden. The user then presses the “show answer” button. FIG. 6c (633), and the answer is shown as displayed in (612). An example of a more complex behavior is provided at paragraph [0069] discussing the different actions of the Math Card based on its interaction-mode and user responses. Each Card-Type may have a separate behavior for each of the three Interaction-Modes. The Review Mode behavior may be different from the Test Mode. Also, Create-Modes may provide an interactive behavior. E.g. the Math-Card-Type shown at in FIG. 6a. The press of the “Calc” button (603) inserts the calculated answer shown under the “SOLUTION” (602).

Content: The content FIG. 2a (204) is the information that is available for the user's consumption. It may be a part of the Card-Types definition created by the Card-Type creator within the non-transitory code, or it may be uploaded by the user at a later time. Content, for the purposes of this description. is human understandable information such as text FIG. 2a (204a), media (204b) as video images or sound, shapes (204c) as drawings, and and are displayed in cells in either the review, test, or create modes. Content is uploaded by the cells and saved to cloud and local memory when the “save” button FIG. 3c (324) is pressed.

A key difference from this invention and prior art in the physical and digital domains for Flash Cards and for Note Cards, is variability in behaviors and in format. As mentioned previously this invention breaks from these concepts, and provides multiple methods to display concise information or a segment of an idea/concept. The variability is provided through common, reusable Interaction-Mode Wrappers for review in FIG. 2a at (201a), test (201b) and create-edit (201c). The wrappers provide the UI interface and the behavior interface for a Card-Type. The invention allows for third parties to create Card-Types as per their needs and as they believe learners and deck-creators need them. It also allows for teaching methods to be implemented in ways that have not been used previously. This invention does not take credit for novel teaching methods that have not been discovered, rather it provides a system for them to be implemented and minimizes costs and software development effort that would be needed for the infrastructure and programming necessary to create them.

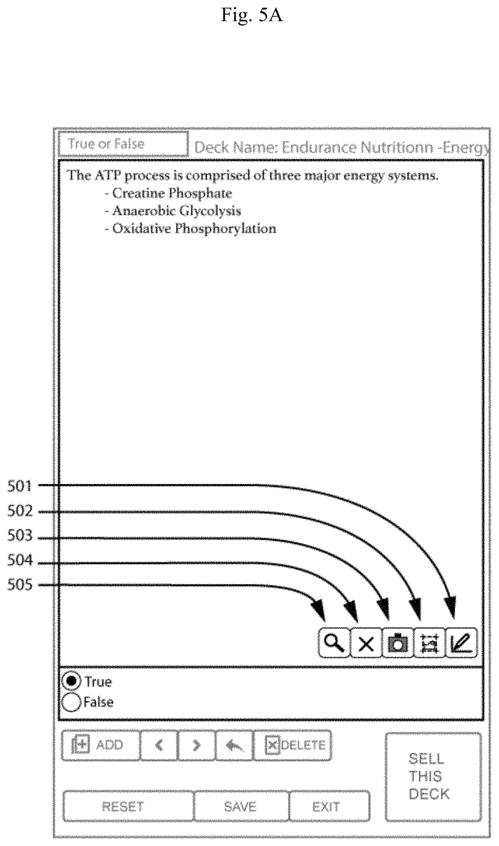

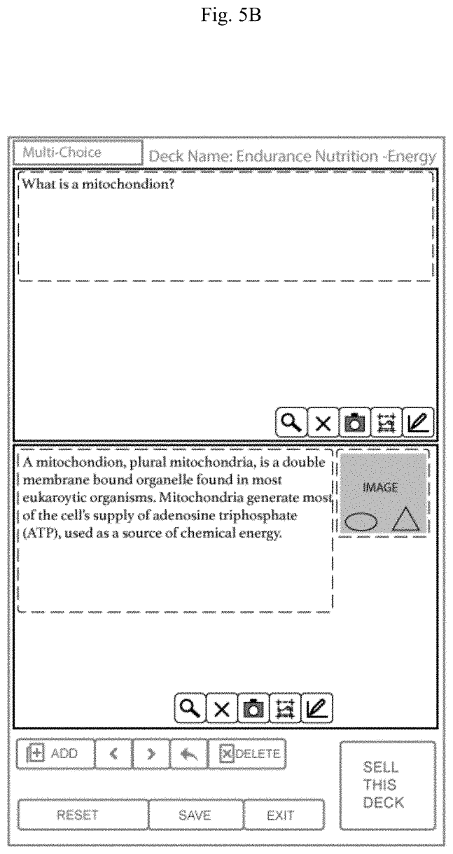

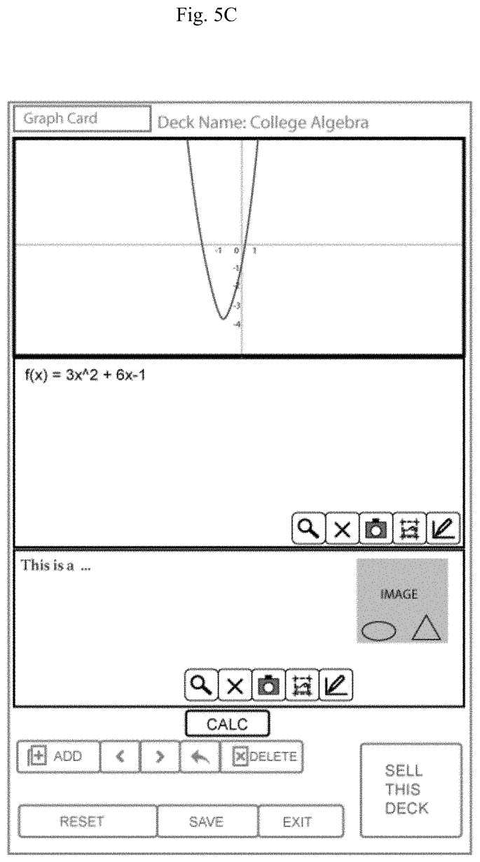

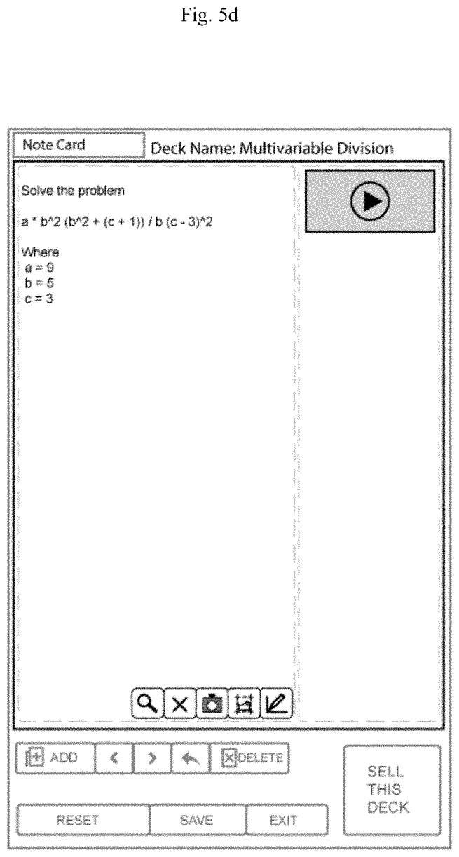

To demonstrate the variability of this invention, a deck of learning content may, for example, cover a segment of a college algebra course. The segment may be the equivalent of a week's worth of information or a single lecture. Within the deck, a series of cards may cover Multivariable Division. The first card may be a note card similar to FIG. 5d that through its definition in non-transitory code provides a single section. The section uses the entire area of the wrapper. The user may decide to add a video of the lecture thus the section has two cells. The cell as seen in FIG. 5d has two cells. In this case the right cell provides a video of the lecture, and the left cell provides a brief text description of the problem covered by the lecture. The second card FIG. 6a Math-Card may be used for a practice problem. If the lecture. The format of the Math-Card may provide two sections stacked horizontally. Where. during creation. the upper section FIG. 6a (601) contains the problem and the lower section (602) contains an explanation and the solution. During learning or Review Mode. FIG. 6b, the same user or another user may review and learn the material in a similar fashion as a flash card where the behavior is the problem given in the upper area (611) and the solution given in the lower area (612) when the user clicks the button (613). For practice they may use test-mode FIG. 6c. In test mode, the upper section provides the problem (621), and the lower section initially starts with an editable text-field for the student to provide their answer. Depending on the Card-Type, the behavior of the card during Test-Mode after the user answers the question may be to respond differently for a correct answer versus an incorrect answer. To continue with the example of the math card in FIG. 6c. the user enters the answer in the text field at (622) and presses the answer button next to it. The behavior for a correct answer may be to change the color of the entry field. If the answer is incorrect, the behavior may be to show the user an interactive step by step break down of how to solve the problem using the correct order of operations. See FIG. 6d where in (632) shows the first expression to be solved as the user hovers their mouse over it, and at (631) the first operator and its variables to be solved in the upper area are displayed by an underline. As the user moves their mouse downward as shown in (634) the corresponding operator and variables are underlined (633). Each interaction-mode of the card-type provides its own behaviors and its own format. This allows a deck to have varied formats and behaviors from card to card depending on the purpose of that card, and the concepts being taught. Then, within the same deck, provide a system for memorialization, free recall testing, and instant feedback.

Each Card-Type provides the fields as non-transitory code to remember the performance of the user, and a unique id for the card that also associates it with the content creator.

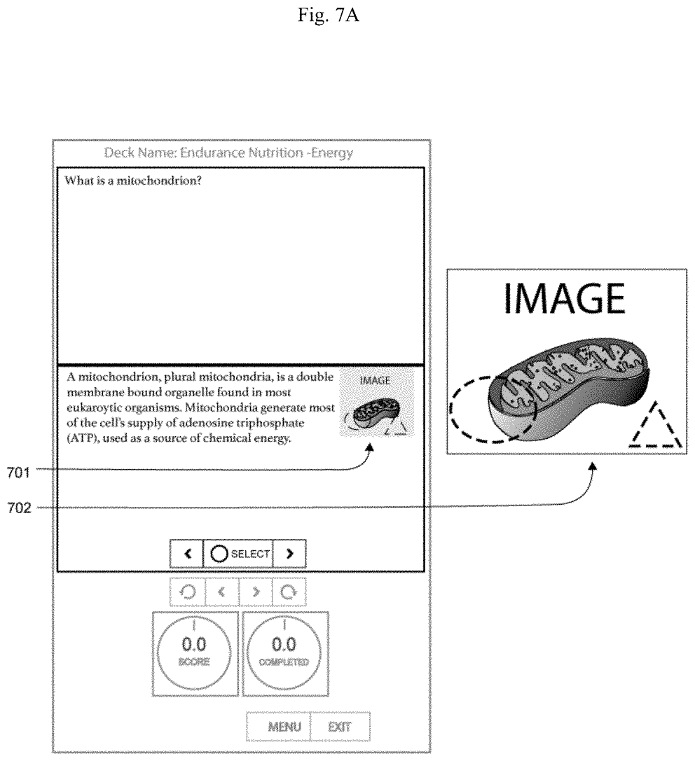

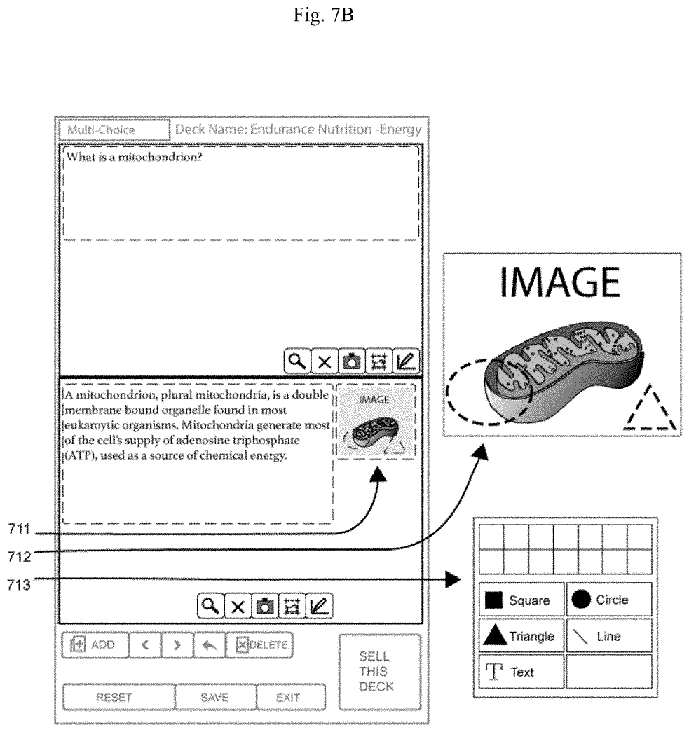

Cell Types: A Cell-Type is the lowest element of a Card. A cell contains the methods needed for content to be created, displayed, scaled, saved, and processed. Cells exist within sections and may be vertically or horizontally stacked. A cell may contain human understandable data such as text, images, video sound and drawings or drawings. A cell may contain layers such as the Canvas Cell which displays an image with a responsive overlay containing annotations such as shapes and text created by the user FIG. 380 at (387). A Cell-Type contains the necessary methods to interact with an editor as shown in FIG. 380. It may provide an interaction such as mentioned with the Math Card FIG. 900, and with the Graph-Card FIG. 390. A Cell-Type is the lowest element of a Card. A cell contains the methods needed for content to be created, edited, displayed, scaled, saved, and processed. Cells exist within sections and may be vertically or horizontally stacked. A cell may contain human understandable data such as text, images, video sound, drawings. A cell may contain layers such as the Canvas Cell which displays an image with a responsive overlay containing annotations such as shapes and text created by the user FIG. 7A. A Cell-Type contains the necessary methods to interact with an editor as shown in FIG. 7A. It may also provide an interaction such as mentioned with the Math Card FIG. 6D, and with the Graph-Card FIG. 5C.

The invention includes predefined cells to provide mem flexibility and re-usability within the application. A format implemented through non-transitory code, is configurable based upon the wishes of the content creator and software configuration of the editor. E.g. for a Multiple-Choice or Multi-Choice Card-Type, the user may want the question to include text and an image. Then may want the correct answer to contain an image with shapes. The Application and the Card Type provides the necessary methods and UI features to facilitate the user with making changes to the card type's format by detecting a drag of a file such as a media file, by providing a delete or add button for removal or addition of a cell, or by providing an interface to the buttons provided in the section editor FIG. 5a.

Some cells may contain behaviors that are common to all Interaction-Modes or may be different for each interaction-mode. E.g. The Image cell provides a behavior that when the user clicks on the cell, the cell provides a popup as displayed in FIG. 7a. The image cell (701) in the Test-Mode for a Multi-Choice Card-Type, when clicked provides the pop-up as displayed at (702). Both review and test modes provide the same popup. However in Create and Edit Mode FIG. 7b the behavior and format allow it to be editable after the user clicks on the image cell (711). Here the popup contains editable shapes in the popup (712) and a draw shapes tool (713). The pop-up applies to all media types. A cell can also provide the behavior of the Card-Type as seen later in the Math-Card Card-Type at FIG. 7d wrong answer response.

Section Types: A Section-Type provides the format for its cells. As shown in FIG. 4. Depending on the selected Card-Type, it may also provide a behavior. Section-Types may be a single cell FIG. 4 (425) or two cells (422 and 423). The number of cells within a section is based on the card-designer, and the user's inputs. The number of sections in a card is based on the card-designer. FIG. 4 displays a Card-Type with three sections, but a Card-Type may contain from 1 to N sections. FIG. 5a the True or False Card-Type and FIG. 5b the Multi-Choice Card-Type have two sections, FIG. 5c the Graph Card Card-Type has three sections and FIG. 5d the Note Card Card-Type has one section. Additionally, sections may contain buttons depending on the interaction-mode and the card-types purpose as shown in the lower section of the Test-Mode in FIG. 5a True or False, where the 1^{st} section has editor buttons while its lower section does not. In 5b both sections have editor buttons.

Decks: Decks are an organization of Cards. Decks exist in multiple data-structure types depending on the needed capabilities of its use. and best performance of time and memory. Information about a deck is stored in a database shown in FIG. 2b at (240) and contains the information about its users, its creator. and its editors. A deck stores information about the last time it was used. the number of times it has been used and when it was created. It also provides a synchronized price set by the original creator. and a price that may be set later.

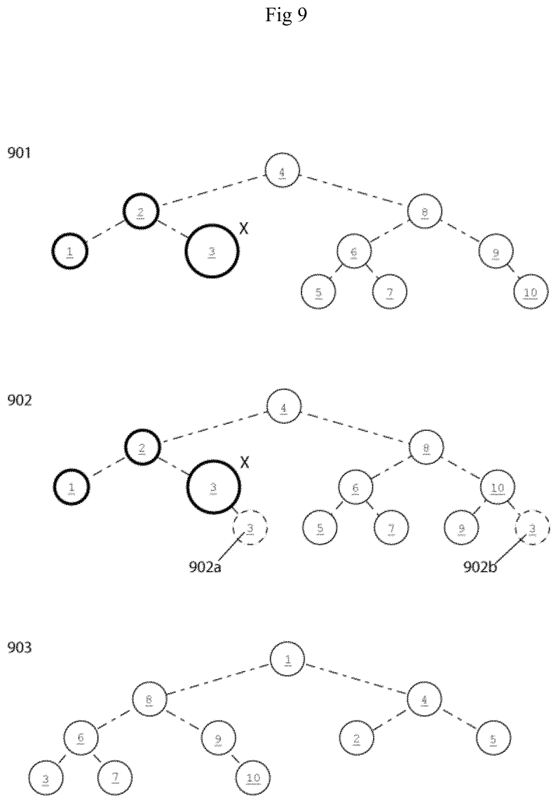

A deck's organization is displayed in a status and navigation pane shown in FIG. 9. The deck may be organized in a data-structure known as a binary-tree and similarly displayed in a visual representation of a binary-tree. The non-transitory code for organization of the deck provides the ability for cards to be placed by a priority that would cause the next session to be reordered. The same non-transitory code may re-order the current session if the user answers a question incorrectly. This organization of a deck can be reset by the user. Additionally, the user may move or change the order of a card within the deck. Movement or reordering is also accomplished by clicking on a cards visual representation within the status and navigation pane, and dragging it to its new location.

Decks may be organized using several Data-Structure Typos. Data-structures for the purpose of this invention are a software engineering and computer science term and the properties that occur due to how the non-transitory code is implemented are applied for several purposes. heir use is novel for this invention from the perspective that they are also used for the display of a deck in the Status and Navigation Pane shown in FIG. 9 at (901, 902 and 903). le ordering of the deck changes based on the performance by the current user. The organization changes both in the current session shown in (901, and 902). and in future sessions (903). As a user interacts with a card performing some action or providing a response such as an answer to a math question, based upon some factors that are implemented by the card-creator such as the amount of time it takes to answer, or a wrong answer, the card, or an associated card-type with the same data, may be re-inserted into the deck at several points within the deck as shown in (902). Here, card 3 has been incorrectly answered and it has been reinserted directly after the card itself (902a), and at the end of the deck or the far right of the tree (902b). In future sessions as shown in (903), the incorrectly answered cards within the deck are reordered so that they are seen earlier. The example (903) shows card 3 on the far-left side of the tree. Cards that have not been seen in the previous session are also moved towards the left as shown by in (903) by the circles representing cards numbered 6, 7, 8, 9 and 10 were not seen in the previous session. The cards that were answered correctly in an earlier session, numbered 1, 2, 4 and 5 are shifted to the right of the deck. If cards continue to be answered correctly at some number, the invention may hide them for some period of time. The organization may be reset by the user and a card may be dragged to another location within the deck by the user. The capability to reorder based on performance both during a session and after the session, as well as the capability to reorder by user control is not novel in the physical world. But is novel in the digital world. Further, no prior art exists for this purpose. that displays an order in a representation of a data-structure known as a balanced binary tree.

Editors: The invention provides a capability for each Card-Type to be edited based on the Card-Type creator's specifications. An editor may be similar to the Section Editor shown for the True or False Card-Type FIG. 5a, the Multi-Choice card-type in FIG. 5b, the Graph-Card Card-Type FIG. 5c. the Note-Card Card-Type FIG. 5A or the Math-Card Card-Type FIG. 6a. An editor provides the necessary methods as non-transitory code to properly display the entry fields of the cells, or fields as specified by the creator's specification. The Card-Type editor may also make use of special tools such as a calculator implemented with non-transitory code that is used in the Math-Card FIG. 6a (703) or graphing calculator FIG. 5c. An editor or section editor exists in the Create Edit Interactive Mode for a card-type. Each section may have its own section editor depending on the Card-Type. The provided section editor as show in FIG. 5a provides 12 buttons that interact with an ability to create shapes (501), take a snapshot from the device screen (502), take a snapshot from the devices camera (503), an ability to delete the text (504), and an ability to search for resources in the ecosystem (505). Snapshot modes started by (502 and 503) provide an ability to quickly annotate the resulting image with shapes and text that is overlaid on top of the image. Additionally, as shown in FIG. 7b. A popup is available when the user clicks on the right/media cell. (711). If the right cell contains an image, the popup will show the image at full scale (712). The popup provides a shape editor as well (713). Shapes in (712) are editable in size, type, color, and position. Additionally, the Create-Edit Mode Wrapper provides an ability for the user to upload and edit metadata about the deck. By clicking on the button at FIG. 3c at (325). the user may elect to allow the deck to sell in the ecosystem.

Search: The application provides a method to search for data stored within a card. The Review Mode may provide a search capability, and the necessary display fields based upon their Card-Type. In a field FIG. 8a (802) in the review-mode of a card-type, a user enters a combination of keywords. In this example “valuation” & “hand”. The non-transitory code conducts a search for all of the cards that contain these terms. The search may be implemented to loosely match the terms in the case that the words are misspelled. The results of the search are displayed in the review mode's wrapper area shown at (801) by providing a brief description. When the user clicks on a result: 1) the corresponding card is displayed in the Review-Mode wrapper FIG. 8b (811). 2) The Navigation and Status Pane FIG. 8C displays the location of the card's index by visually pulsing the representation within the display (821). 3) The card. here represented as a circle. grows and contracts representing the current sequential position of the information as shown by the inner circle and the outer circle at (821). When the user clicks off of the found card, the visually pulsing representation stops pulsing and returns to the original shape and size and the wrapper returns to the currently visited card.

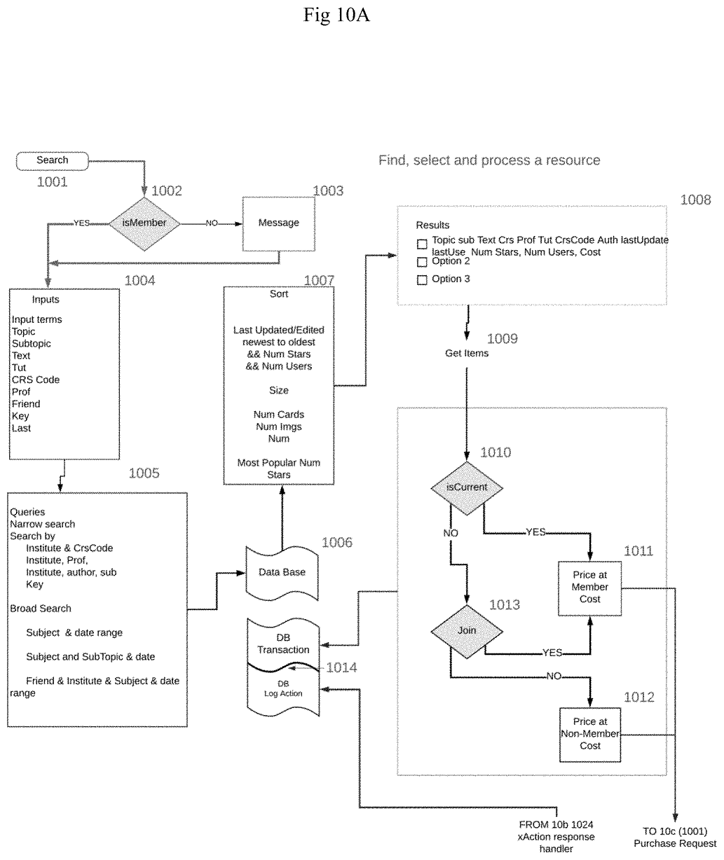

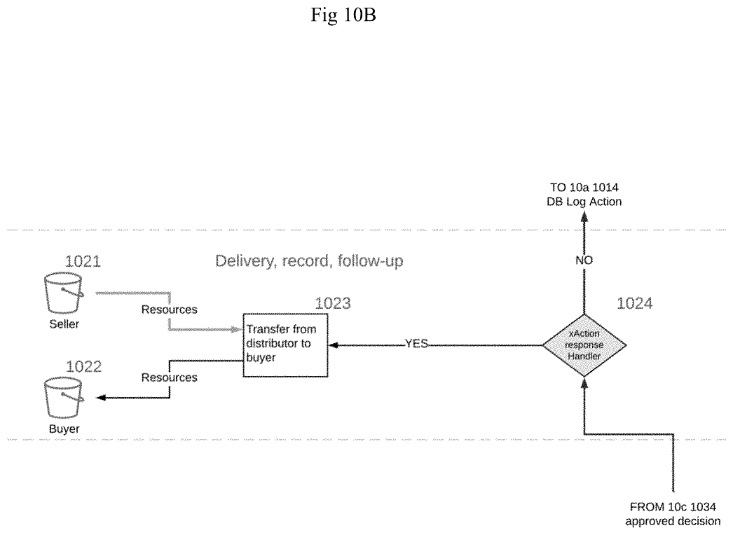

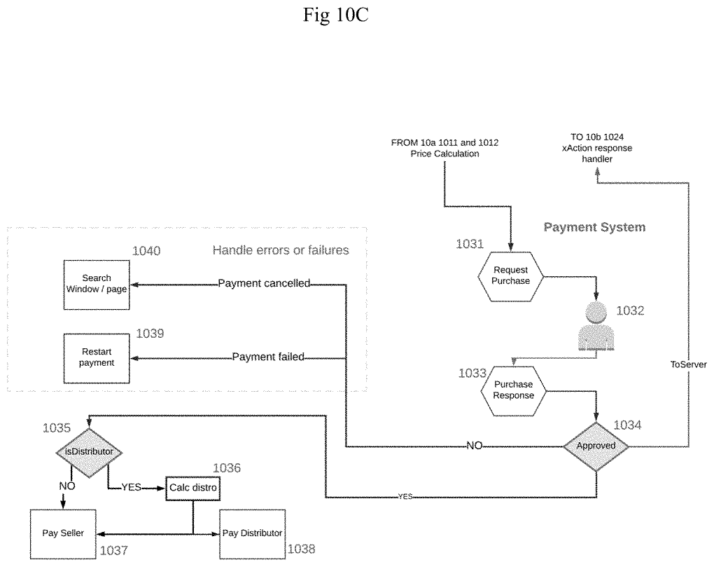

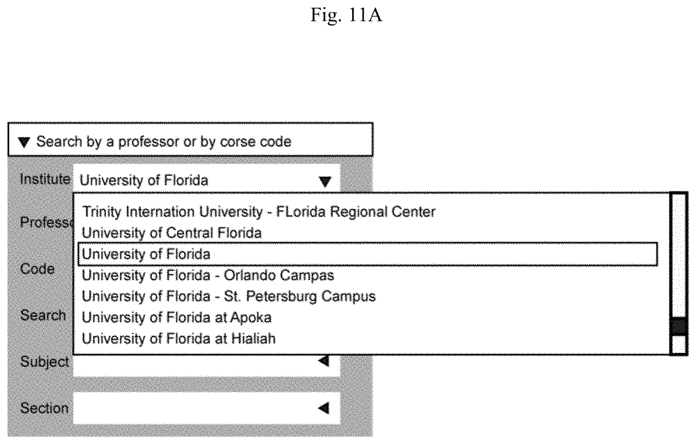

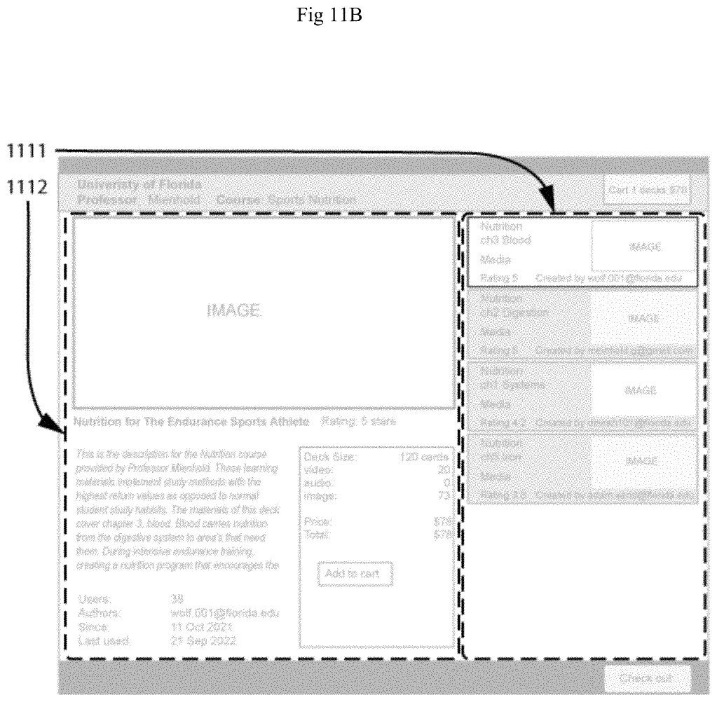

Exchange System: The exchange system is non-transitory code that exists on a server (113) shown in FIG. 2b at (243). in a database (240) and FIG. 10a (1006 and 1014). in memory storage FIG. 2b (241) and FIG. 10b (1021 and 1022). and on the users' computer system FIG. 1. represented graphically to the user as FIG. 11a Ecosystem Search and FIG. 11b Ecosystem Results as part of the application. This invention, through processing of the non-transitory code in electrical machinery in all four locations, provides the ability for the exchange of concise information formatted as described by this invention. Through this system this invention provides a method of Ownership Assurance where users can own content formatted as described as a deck, and exchange it for some value. Further, this method provides a user to be an independent entity from the system owner and exchange it with another independent entity from the system owner. The content creator and owner can earn cash in exchange for content stored and formatted as described previously. Further this invention provides an ability for other independent entities to participate in exchanges by some action such as editing the content and redistributing the content independent of the original creator. The invention provides a means to compensate the original creator, and future editors.

Shown in the Resource Exchange System Chart FIG. 10a the user clicks the search button (1001) either in the Application or browser A check is conducted to find if the user is subscribed FIG. 10a (1002). If not, then a message is sent to the user (1003) and the user continues to an input form that allows them to subscribe. If true, FIG. 11a. The user 1) selects the type of search and, 2) provides the criteria for the search then 3) clicks a submit button. e information provided by the form is one of the criteria in FIG. 10a (1004) and based on the type of search, a query from (1005) is used. The database (1006) returns the results and then they are sorted (1007) based on the selected criteria for sort. The user selects the desired items from the display results (1008) and shown in FIG. 11b (1111) selects one of the vertically displayed decks on the right-hand side of the pane for purchase. A request is sent to the server FIG. 10a at (1009) to “get” the purchased items (1009) metadata and images that is then displayed FIG. 11b (1111 and 1112). The server checks if the user “is current” FIG. 10a (1010). If the user is not current nor a subscriber (1020) the price is calculated at one price (1011). If the user is not current and or not a subscriber (1030) the price is calculated at a lower price (1012). These actions may be logged in the database at (1014). A request is sent to the payment system FIG. 10c (1031) and a pay form is sent to the user (1032).

If the user fills in the pay form and submits the information, the purchase response is sent back to the payment system (1033). If the payment is approved (1104) (1034) the proceeds from the sale, minus fees and taxes, are calculated (1036) and given to the seller (1037), and if selected (1035) the distributor (1038). If the payment failed at (1034) actions are taken by (1181) to restart the payment (1039), or if the payment was cancelled by the user, the user is returned to the search window page (1040) and FIGS. 11a and 11b.

A message is sent by the purchase system that the purchase was successful at FIG. 10c (1034). A listener on the server at FIG. 11b (1024) provides the actions based on if the purchase was successful or failed. If the purchase was successful, the deck is transferred by the transfer handler FIG. 10b (1023) from the seller's location in the cloud or on-site memory (1021) to the buyer's location in the cloud or on-site memory (1022). The payment attempt is recorded in the Data Base at (1061) or (1062). FIG. 10a (1014).

1. A non-transitory computer program running independently on a computer as an application that when executed through computer hardware and processors causes visual displays, sounds, images, and video to be executed, based on those lines of code. Additionally, content and the necessary visual displays and hardware input devices function in a way that a user or multiple users may create content for later review on the same or other computer devices. The content is non-transient code stored in the computer's memory devices and may also be stored on remote memory that exists on computing devices in other locations from the user. Content is associated with a card-type, which causes a variable system of methods, so each card may be different in appearance, behavior, and purpose from one to the next.

2. The computer program of claim 1, provides for each card a method for providing a unique identifier that includes an identifier from the user who created the card.

3. The computer program of claim 1, provides for each flash card a method for creating storing and retrieving and updating meta-data that provides information about a user's previous sessions.

4. The computer program of claim 1, provides a model that is a blue print for the content that it contains. Content includes text, images, video, sound, and drawings or annotations. The model also includes behaviors and interactions. This model is a ‘Card Type’ or ‘type’. The Card Type consists of behaviors, formats, and eventually data and is similar to a programmable blue print that controls how the computing device shall display the content, images, video, animations, play sound, and interact with the user through input devices.

5. A behavior as mentioned in claim 4 is a non-transitory plurality of code that causes an action that may, for example, include the playing of an animation, may be based on a user's inputs, and or may walk a learner through a simulation or concept in biology such as the ATP process, or mathematics such as polynomial division. The behavior may be simple, such as the playing of a video, complex such as interacting with a user to demonstrate the interaction of a biological cell's energy process in the ATP process, or may be static and beno action at all. Each card type shall contain at least two behaviors. A behavior for editing known as Create-Moe and a behavior for review known as Review-Mode. It may also provide a separate behavior for testing known as Test-Mode.

6. A format as mentioned in claim 4 is a non-transitory plurality of code that creates the users display to provide information in a particular visual layout. For instance, a format might be configured so that a question that is in a multiple-choice type visually creates an area for a question to be in the top half of the screen and contains textual data on the left, and a video or an image on the right. The possible answers appear below the answer as text on the left and video or images on the right. Buttons exist to allow the user to navigate from one answer to the next and to select the correct answer.

7. A format as mentioned in claim 4 consists of sections that may range from 1 to N in number.

8. A section as mentioned in claim 7 consists of cells. Cells are the lowest format element that is contained in a Card Type. A Cell is created by a non-transitory plurality of code and contains data and a behavior. E.g. if the cell contains a video, the behavior of the cell may be to show an image with a play symbol representing that the cell contains a video. Upon a user clicking on the cell, a video player pop-up is displayed. A cell may contain layers such as to display an image with a drawing containing shapes and text to highlight an area of key interest.

9. Special Cells exist as mentioned in claim 8 as a non-transient plurality of code that allows an annotation to appear over images. Annotations may be used to highlight and call attention to the user during review of the flash card. The annotation can appear as a brightly colored or contrasted shape.

10. Shapes as mentioned in claim 9 are a non-plurality of code that are visually displayed as a square or circle or as can be created by the shape editor. Shapes are editable so that they may be changed in the future.

11. Special Cells exist as mentioned in claim 9 that provide a popup of an image or video so that it may be edited, manipulated, and reviewed using the cells edit and review behaviors.

12. The content as mentioned in claim 4 may be provided by a card creator, or may be uploaded by a user.

13. Content as mentioned in claim 4 is editable at later dates by a section editor and if allowed by permissions.

14. Card Types as mentioned in claim 4 are a non-transient plurality of code that is user selected and exist from 1 to N allowing for flexibility and for 3^{rd} party entities to participate in new Card Type creation. A Card Type is selected during card creation, or during editing of the card. The card type will be used when the user is using the review or test mode.

15. The application mentioned in claim 1 provides a ‘create mode’ as a non-transitory plurality of code to insert content or the required actions needed to be performed by the user to make the Card Type usable in its intended behavior and format. E.g. if the Card Type is a multiple-choice type, the cells mentioned in claim 8 provide the necessary create and edit capabilities for that type. The type provides the proper format mentioned in claim 6 for the cells to be edited as well as any coordinating non-transitory code that is needed to provide the correct editing behaviors.

16. The application mentioned in claim 1 provides a Review-Mode as a non-transitory plurality of code based upon the card types that exist and the data that is provided for that card type. Each card type provides a review behavior as mentioned in claim 5 for review. E.g. if the card type is a multiple-choice type then the review mode is a simple question and answer that is similar to a physical flash card. Where the user sees a question as text or multi-media based on the flash cards data, then presses the answer button to see the answer.

17. The review mode mentioned in claim 16 may be simple by showing the question on one button press, and then show the answer on the next button press. It may be complex such as an interactive animation of a part of a complex multi-part concept such as the ATP process.

18. The application mentioned in claim 1 may provide a ‘test mode’ from a non-transitory plurality of code. The test mode differs from the review mode in that it contains scoring and behaves separately from the review mode. E.g. a multiple-choice card type behaves similar to a flash card in review mode but provides multiple possible answers in test mode.

19. The test mode mentioned in claim 18, provides a method for scoring based on correct and incorrect answers.

20. The method for scoring mentioned in claim 19, provides an ability to store the score as non-transient plurality of code for use both at the current time, and in the future.

21. The application mentioned in claim 1 provides a plurality of non-transitory code for organizing a deck of cards and to represent their organization visually as a status and display tree. Each flash card has a priority for their index within the tree based upon the last time a user has seen the card, and the user's performance in answering the card.

22. The priority mentioned in claim 21 is based upon information that is stored by the card type and may be based upon several factors such as time and the number of correct and incorrect answers.

23. The status and display tree mentioned in claim 21 organizes by a biased organization system. A card is weighted based on if a user's response is correct, incorrect, or partially correct. The deck reorganizes for the current session and for future sessions. The current session is reorganized when the user provides an incorrect response. When this occurs, the flash card is re-inserted into the organization and status tree for repeated review within multiple locations of the deck. If that flash card is incorrectly answered again, the program changes the priority of the card for the next review of the deck and it is indexed to be seen earlier in the next session. If the flash card is answered correctly its priority changes and is indexed so that it is seen later in the session or may not be seen at all. If a visible card is not visited by the user during that session it will be indexed to appear earlier in the next session. If a card has just been added it will be indexed to appear earlier in the next session.

24. Search: The application mentioned in claim 1 provides a method as a non-transitory plurality of code to search for information that is stored in the decks. The search method is highly efficient based on time and memory and uses the information that is stored in single or multiple decks. The search field may contain from 1 to N terms that are found in one or more flash cards. The results of the computer programs search are then displayed to the user. When the user selects a result. That flash card is then displayed to the user.

25. The search mentioned in claim 24 may be used to search for flash cards that exist on the user's computer or in the cloud.

26. The application mentioned in claim 1 provides the necessary elements as a non-transitory plurality of code so that a deck and its multi-media may be organized and maintain edits and additions to a deck, and so that a deck if downloaded from another system shall show the latest edits from the other system. The cloud synchronization system allows downloads from users who have access rights and restricts it from users who do not have access rights.

27. The Cloud Synchronization and Storage system mentioned in claim 26 provides a method to store, find, update, retrieve, and delete content in an efficient synchronized manner and with other independent data that may exist in volumes greater than 1000 TB.

28. The application mentioned in claim 1 provides the cloud synchronization and storage mentioned in claim 23 as an option. A user can create, edit, review, and test using the flash cards in a deck without being connected to the internet.

29. The application mentioned in claim 1 as a non-transitory plurality of code provides security of itself, the user, and the decks to maintain privacy of information, and prevent the loss of the information.

30. The application mentioned in claim 1 as a non-transitory plurality of code provides ownership assurance for each flash card.

31. Ownership Assurance as mentioned in claim 30 as a non-transitory plurality of code is accomplished by providing an identity to the information that may be based on its appearance if an image or a video, or on the user's information.

32. An Exchange system as a non-transitory plurality of code to find decks and other possible learning materials that are available from others that have been uploaded to the cloud. The application mentioned in claim 1 and this system provides the required actions needed to be performed by the user to make a deck available in the cloud, to purchase a deck from another user, and to use the purchased deck.

33. The Exchange system mentioned in claim 32 provides a method to provide information about the decks users, creators and editors.

34. The Exchange system mentioned in claim 32 provides a method to provide the last time a deck was used. How many users have used the deck. Who created the deck, and who has edited the deck. And or users associated with the viewer.

35. The application mentioned in claim 1 provides the user an option to store information about themselves called ‘profile data’ as a non-transitory plurality of code. A method is provided by the application to create edit and display the user's profile, and a method is provided to store and retrieve the profile data.
